(19) United States
(12) Patent Application Publication
(10) Pub. No.: US 2020/0211383 A1
(43) Pub. Date: Jul. 2, 2020

(54) Automatic command device that mimics a traffic police

(71) Applicant: Huimin He, Qingdao City (CN)

(72) Inventor: Huimin He, Qingdao City (CN)

(21) Appl. No.: 16/816,293

(22) Filed: Mar. 12, 2020

(30) Foreign Application Priority Data
Nov. 11, 2019 (CN) 2019110958429

(51) Int. Cl. G08G 1/09; B05B 13/00; B05B 9/04; G08G 1/005; E01F 9/00; F04D 29/40; F24F 5/00

(52) U.S. Cl. CPC G08G 1/09; B05B 13/005; B05B 9/0426; F24F 5/0035; E01F 9/00; F04D 29/403; G08G 1/005

(57) ABSTRACT

The invention discloses an automatic command device for imitation traffic police, which includes a fuselage, a first support rod is fixedly installed on the upper side of the stop card base, a stop card is fixedly installed on the right side of the first support rod, and a screw thread rotates to drive a thread. The push plate moves to the right, the threaded push plate moves to the right to squeeze out the water in the water storage tank through the water spray valve, control the command of the “stop” sign through the rack and pinion, and control the “passing” sign through the linkage mechanism. Command, design the screw and other transmissions, after pumping the water under the ground into the water storage tank, while showing the “stop” sign, the push plate squeezes the water out of the water storage tank and sprays on the ground to remind pedestrians and Vehicles should not do illegal acts, which will not hurt pedestrians or provide a warning effect.

### CROSS-REFERENCES TO RELATED APPLICATIONS

The present application claims priority from Chinese application No. 2019112157069 filed on Sep. 19, 2019 which is hereby incorporated by reference in its entirety.

### TECHNICAL FIELD

The invention relates to the field of traffic command, in particular to an automatic command device that mimics a traffic police.

### BACKGROUND OF THE INVENTION

There are more and more people with cars, which means that there are more and more vehicles on the road. If there are no traffic rules and there are indicators of vehicles on the road, then the vehicles on the road must be mixed and blocked. There is no traffic at all, and the traffic police in the news recently commanded more and more personal injuries. The traffic police gradually became a high-risk occupation, and they worked on the roads in summer and winter. The harm is also great, so it needs to be invented to solve the above problems.

### BRIEF SUMMARY OF THE INVENTION

The purpose of the present invention is to provide an automatic command device that mimics a traffic police, which is used to overcome the above defects in the

### PRIOR ART

An automatic command device mimicking a traffic police according to an embodiment of the present invention includes a fuselage. The fuselage is provided with a stop card space opening to the right, and the stop card space is provided with a command component for command. The description will only include a stop card base slidingly installed in the stop card space. A first support rod is fixedly installed on the upper side of the stop card base, and a stop card is fixedly installed on the right side of the first support rod. On the upper side of the card space, there is a passing card space with an upward opening. A second supporting rod is slidably installed in the passing card space. A passing card is fixedly installed on the upper side of the second supporting rod. The first supporting rod drives the stop. The card slides to the right on the right wall of the stop card space, the stop card instructs pedestrians and vehicles to stop walking or driving forward, and the second support rod drives the pass card to slide up to the top wall of the pass card space Above, the pass sign indicates that pedestrians and vehicles can walk or drive forward to complete automatic command,

The lower side of the spray valve is provided with a threaded screw space. The threaded screw space is provided with a warning component for warning pedestrians or vehicles approaching or crossing the warning line. The warning component includes a sliding installation in the threaded screw space. A threaded pusher, a water storage tank is connected to the lower side of the threaded screw space, the water storage tank is slidably connected to the threaded pusher, the upper side of the threaded pusher is rod-shaped, and the lower side is disc-shaped When the threaded push plate is moved to the right, the water in the water storage tank can be squeezed out and sprayed on the ground, and it can give a warning effect to pedestrians or vehicles doing dangerous actions.

On the basis of the above technical solution, the command component further includes a gear space provided on the lower side of the stop card space and communicating with the stop card space, and a helical gear space is provided on the rear side of the gear space, and the helical gear A motor is fixedly installed in the rear wall of the space, and a driving shaft is fixedly installed on the output shaft of the motor. A gear space is fixedly installed in the gear space on the driving shaft, and the gear space is engaged with the stop sign base.

On the basis of the above technical solution, a spring space is provided on the left side of the stop card space in communication with the stop card space. A first slider is slidably installed in the spring space, and a right side surface of the first slider is installed in the spring space. A first energized magnet is fixedly installed, a push rod is slidably installed on the right side of the first slider in the spring space, and a first permanent magnet is fixedly installed on the left side of the push rod. The left wall of the spring space and the A first spring is fixedly installed between the left side of the first slider, a second spring is fixedly installed between the right side of the first energized magnet and the left side of the first permanent magnet, and the upper side of the first slider A fixed rod is fixedly installed, a hinge is connected to the rocker on the fixed rod, a pass card space with an upward opening is provided on the upper side of the stop card space, and the pass card space is slidably connected with the second support rod. A hollow fixing block is fixedly installed on the lower side of the second support rod, and a second permanent magnet is fixedly installed on the lower side of the hollow fixing block. A second energizing magnet is fixedly installed in the bottom wall of the pass space. Said second electromagnetic Fixedly mounted on the side between the third spring, the rocker is slidably connected to said hollow fixing block.

On the basis of the above technical solution, the warning component further includes a helical gear space provided on the rear side of the gear space, and a first helical gear is fixedly installed in the helical gear space on the driving shaft, and the helical gear space A threaded screw space is provided on the left side, and a threaded screw is installed between the left and right walls of the threaded screw space. A second helical gear is fixedly installed in the helical gear space on the threaded screw, and the second helical gear and the The first helical gear meshes, and a threaded push plate is threadedly installed on the threaded screw. A water storage tank is connected to the lower side of the threaded screw space, and the threaded push plate extends into the water storage tank. A spray head is provided between the right wall and the right side of the fuselage. A water spray valve is fixedly installed in the spray head, a water inlet valve is fixedly installed in the bottom wall of the water storage tank, and a lower side of the water inlet valve is fixedly installed. A support column that passes into the water, and the lower side of the support column is fixedly installed in the ground.

On the basis of the above technical solution, the front side of the gear space is provided with a fan blade space opening forward, the fan shaft is fixedly installed in the fan blade space, and the front wall of the fan blade space is fixedly installed. Filter to prevent injury by fan blades.

On the basis of the above technical solution, a water inlet pipe is provided in the rear wall of the water storage tank, a water outlet valve is fixedly installed in the water inlet pipe, a water pump is fixedly installed in the body, and the water pump input port and the water inlet A water pipe is fixedly connected, and an output water pipe is fixedly connected to an output port of the pump.

The beneficial effects of the present invention are: the present invention controls the command of the “stop” sign through the rack and pinion, controls the command of the “pass” sign through the linkage mechanism, designs the screw and other transmissions, and pumps the water under the ground into the water storage tank Later, while showing the “stop” sign, the push plate squeezed the water out of the water storage tank and sprayed on the ground to remind pedestrians and vehicles not to violate the rules, which would not hurt the pedestrians and also acted as a warning. It is worth promoting.

### BRIEF DESCRIPTION OF THE DRAWINGS

In order to more clearly explain the embodiments of the present invention or the technical solutions in the prior art, the drawings used in the embodiments are briefly introduced below. Obviously, the drawings in the following description are just some of the present invention For those of ordinary skill in the art, other embodiments may be obtained based on these drawings without paying creative labor.

FIG. 1 is a schematic diagram of the overall structure of the present invention;

FIG. 2 is a cross-sectional view of A-A in FIG. 1 of the present invention;

FIG. 3 is a sectional view taken along the line B-B in FIG. 1 of the present invention.

### DETAILED DESCRIPTION OF THE INVENTION

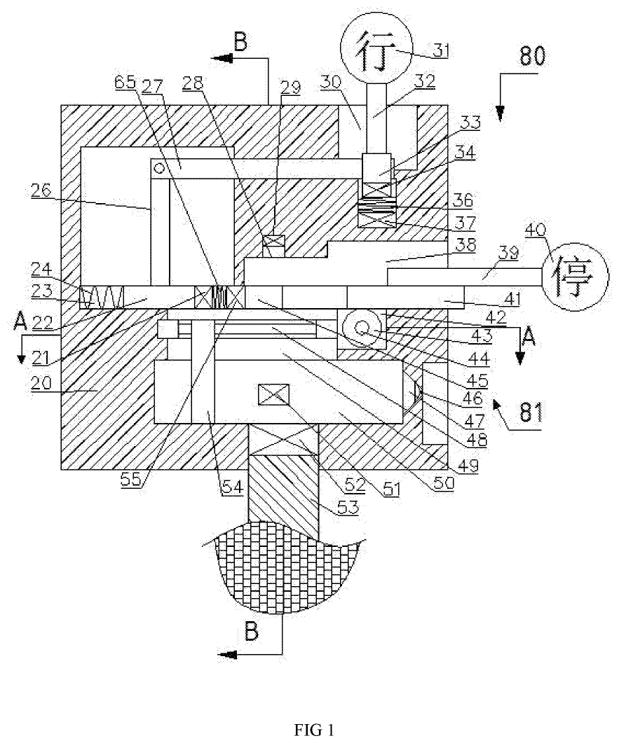

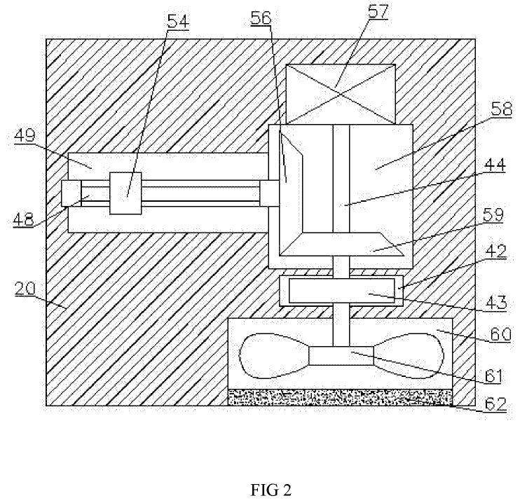

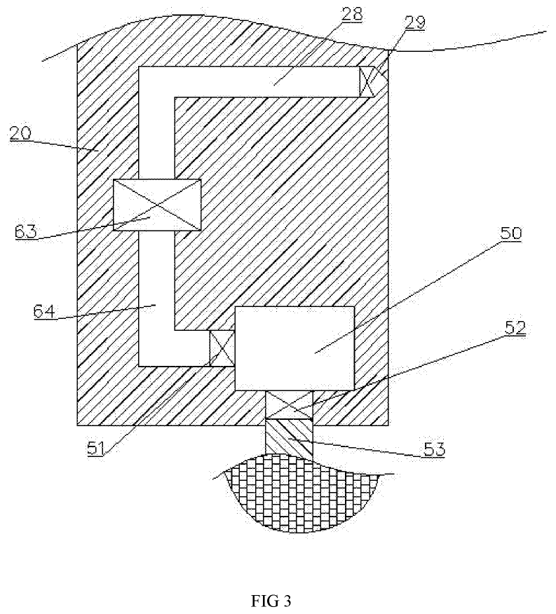

The present invention will be described in detail below with reference to FIGS. 1-3. Among them, for convenience of description, the orientation described below is defined as follows: the up-down, left-right, front-back, and up-down directions described below are consistent with the front-back, left-right, up-down, and down directions of the view direction of FIG. 1, 1 is a front view of the device of the present invention, and the direction shown in FIG. 1 is the same as the front, rear, left, right, and up and down directions of the device of the present invention.

Referring to FIGS. 1-3, an automatic command device for imitation traffic police according to an embodiment of the present invention includes a fuselage 20, and the fuselage 20 is provided with a stop card space 38 which opens to the right, and the stop card space 38. There is a commanding component 80 for commanding. The only sight 80 includes a stop card base 41 slidably installed in the stop card space 38. A first support rod 39 is fixedly installed on the upper side of the stop card base 41. A stop card 40 is fixedly installed on the right side of the first support rod 39, and a pass card space 30 with an upward opening is provided on the upper side of the stop card space 38. A second support rod 32 is slidably installed in the pass card space 30. A pass plate 31 is fixedly installed on the upper side of the second support rod 32. The first support rod 39 drives the stop plate 40 to slide to the right to the right wall of the stop plate space 38. The stop plate 40 indicates pedestrians and vehicles. Stop walking or driving forward, the second support rod 32 drives the pass 31 to slide upward to the top wall of the pass space 30, and the pass 31 indicates that pedestrians and vehicles can walk or drive forward, and is completed Automatic command,

A threaded screw space 49 is provided on the lower side of the spray valve 29, and a warning component 81 for warning pedestrians or vehicles approaching or crossing the warning line is provided in the threaded screw space 49, and the warning component 81 includes a sliding installation The threaded push plate 54 in the threaded screw space 49 is provided with a water storage tank 50 on the lower side of the threaded screw space 49. The water storage tank 50 is slidably connected to the threaded push plate 54. The upper side is in the shape of a rod, and the lower side is in the shape of a disk. Moving the threaded push plate 54 to the right can squeeze out the water in the water storage tank 50 and spray it on the ground. It can be used for pedestrians or vehicles doing dangerous actions. Be alert.

In addition, in an embodiment, the command component 80 further includes a gear space 42 provided on the lower side of the stop card space 38 and communicating with the stop card space 38, and a helical gear is provided on the rear side of the gear space 42 A space 58, a motor 57 is fixedly installed in the rear wall of the helical gear space 58, a driving shaft 44 is fixedly installed on the output shaft of the motor 57, and a gear space 43 is fixedly installed in the gear space 42. The gear space 43 meshes with the stop card base 41. When the pedestrian and the vehicle need to be instructed to stop, the motor 57 is started. The motor 57 drives the driving shaft 44 and the gear space 43 rotates. The gear space 43 drives the stop card base 41 to move to the right and stops. The card base 41 drives the first support rod 39 and the stop card 40 to the right to stop the command. After the command is completed, the gear space 43 drives the stop card base 41 to the left, and the stop card base 41 drives the pass card space 30 and the stop card 40 to the left. Move left and finish stopping command.

In addition, in one embodiment, a spring space 23 is provided on the left side of the stop card space 38 in communication with the stop card space 38, and a first slider 22 is slidably installed in the spring space 23, and the first A first energizing magnet 21 is fixedly installed on the right side of the slider 22, and a push rod 45 is slidably installed on the right side of the first slider 22 in the spring space 23, and a first A permanent magnet 55, a first spring 24 is fixedly installed between a left wall of the spring space 23 and a left side surface of the first slider 22, and a right side surface of the first energizing magnet 21 and a left side of the first permanent magnet 55 are fixedly installed. A second spring 65 is fixedly installed between the sides, and a fixed rod 26 is fixedly installed on the upper side of the first slider 22. The fixed rod 26 is hinged to the rocker 27. The stop card space 38 is provided on the upper side. A passing card space 30 with an upward opening, the passing card space 30 is slidably connected to the second support rod 32, and a hollow fixing block 33 is fixedly installed on the lower side of the second support rod 32, and the lower side of the hollow fixing block 33 is fixed A second permanent magnet 34 is installed, and a second power supply is fixedly installed in the bottom wall of the pass space 30 Iron 37, a third spring 36 is fixedly installed between the lower side of the second permanent magnet 34 and the upper side of the second energized magnet 37, and the rocker 27 is slidably connected with the hollow fixing block 33 to stop the card base 41 The leftward movement drives the push rod 45, the first permanent magnet 55, the second spring 65, the first energized magnet 21, and the first slider 22 to the left. The first slider 22 drives the fixed rod 26 and the rocker 27 to slide to the right. The rocker 27 no longer fixes the hollow fixing block 33, and does not apply electricity to the second energized magnet 37. The third spring 36 drives the second permanent magnet 34, the hollow fixing block 33, the second support rod 32, and the pass 31 to move upward to complete Traffic command.

In addition, in one embodiment, the warning component 81 further includes a helical gear space 58 provided on the rear side of the gear space 42, and a first helical gear is fixedly installed in the helical gear space 58 on the driving shaft 44. 59. A threaded screw space 49 is provided on the left side of the helical gear space 58, and a threaded screw 48 is installed between the left and right walls of the threaded screw space 49. The threaded screw 48 is fixedly installed in the helical gear space 58. Two helical gears 56, the second helical gear 56 meshes with the first helical gear 59, a threaded push plate 54 is threadedly installed on the threaded screw 48, and a water storage tank 50 is connected to the lower side of the threaded screw space 49 The threaded push plate 54 extends into the water storage tank 50. A spray head 47 is provided between the right wall of the water storage tank 50 and the right side of the fuselage 20, and a spray head is fixedly installed in the spray head 47. Water valve 46, a water inlet valve 52 is fixedly installed in the bottom wall of the water storage tank 50, and a support column 53 for water inlet is fixedly installed on the lower side of the water inlet valve 52, and the lower side of the support column 53 is fixedly installed in the ground. When a pedestrian or a vehicle approaches the warning line, the water inlet valve 52 is opened, and the water tank 50 is filled with water. Water, rotation of the driving shaft 44 drives the first helical gear 59, the second helical gear 56, and the threaded screw 48. The rotation of the threaded screw 48 drives the threaded push plate 54 to the right, and the threaded push plate 54 moves to the right to store the water in the storage tank 50 The water is squeezed out through the water spray valve 46 to warn pedestrians and vehicles not to violate the rules.

In addition, in one embodiment, the front side of the gear space 42 is provided with a fan blade space 60 opening forward, and the driving shaft 44 is fixedly installed in the fan blade space 60 and the fan blade 61 is fixed. The front wall of the space 60 is fixed with a filter 62 to prevent injury from the fan blades. The rotation of the driving shaft 44 drives the fan blades 61 to rotate to generate wind, and cools waiting pedestrians.

In addition, in one embodiment, a water inlet pipe 64 is provided in the rear wall of the water storage tank 50, a water outlet valve 51 is fixedly installed in the water inlet pipe 64, and a suction pump 63 is fixedly installed in the body 20. The input port of the water pump 63 is fixedly connected to the water inlet pipe 64. The output port of the suction pump 63 is fixedly connected to the output water pipe 28. The suction pump 63, the water outlet valve 51 and the spray valve 29 are turned on. Draw out to spray valve 29, spray and cool.

Initially: the stop card base 41 moves to the left wall of the stop card space 38 to energize the second energizing magnet 37, and the second energizing magnet 37 drives the second permanent magnet 34 and the hollow The fixed block 33, the second support rod 32, and the pass card 31 are moved downward into the pass card space 30;

When in use: When it is necessary to instruct pedestrians and vehicles to stop, start the motor 57, the motor 57 drives the driving shaft 44, the gear space 43, the gear space 43 drives the stop card base 41 to move to the right, and the stop card base 41 drives the first support rod 39 1. The stop card 40 moves to the right to stop the command. After the command is completed, the gear space 43 drives the stop card base 41 to move to the left, the stop card base 41 drives the pass card space 30, and the stop card 40 moves to the left to complete the stop command and stop card. The left movement of the base 41 drives the push rod 45, the first permanent magnet 55, the second spring 65, the first energized magnet 21, and the first slider 22 to the left, and the first slider 22 drives the fixed rod 26 and the rocker 27 to Slide it to the right, the rocker 27 no longer fixes the hollow fixing block 33, and the second energized magnet 37 is not energized. The third spring 36 drives the second permanent magnet 34, the hollow fixing block 33, the second support rod 32, and the pass 31 to move upward. To complete the traffic command,

When a pedestrian or a vehicle approaches the warning line, the water inlet valve 52 is opened, and water is injected into the water storage tank 50. The rotation of the driving shaft 44 drives the first helical gear 59, the second helical gear 56, and the threaded screw 48 to rotate, and the threaded screw 48 rotates to drive The threaded push plate 54 moves to the right, and the threaded push plate 54 moves to the right to squeeze the water in the water storage tank 50 through the water spray valve 46 to warn pedestrians and vehicles not to violate the rules. The active shaft 44 rotates to drive the fan blades. 61 rotates to release air, cool the waiting pedestrians, turn on the suction pump 63, the outlet valve 51, and the spray valve 29. The suction pump 63 extracts the water in the water storage tank 50 to the spray valve 29 for spray cooling.

The beneficial effects of the present invention are: the present invention controls the command of the “stop” sign through the rack and pinion, controls the command of the “pass” sign through the linkage mechanism, designs the screw and other transmissions, and pumps the water under the ground into the water storage tank Later, while showing the “stop” sign, the push plate squeezed the water out of the water storage tank and sprayed on the ground to remind pedestrians and vehicles not to violate the rules, which would not hurt the pedestrians and also acted as a warning. It is worth promoting.

Those skilled in the art can clearly understand that various modifications to the above embodiments can be made without departing from the overall spirit and concept of the present invention. They all fall within the protection scope of the present invention. The protection scheme of the present invention is subject to the claims attached to the present invention.

1. An automatic command device for a traffic police, comprising a fuselage, wherein the fuselage is provided with a stop card space opening to the right, and the stop card space is provided with a command component for commanding, Only the stop card base including the stop card space slidingly installed on the stop card base is fixed, and the first support rod is fixedly installed on the upper side of the stop card base, and the stop card is fixedly installed on the right side of the first support rod. On the upper side of the space, there is a passing card space with an upward opening. A second supporting rod is slidably installed in the passing card space. A passing card is fixedly installed on the upper side of the second supporting rod. The first supporting rod drives the stop card. Slide right to the right wall of the stop card space, the stop card instructs pedestrians and vehicles to stop walking or driving forward, and the second support rod drives the pass card to slide upward to the top wall of the pass card space The pass sign indicates that pedestrians and vehicles can walk or drive forward, and complete automatic command,
The lower side of the spray valve is provided with a threaded screw space. The threaded screw space is provided with a warning component for warning pedestrians or vehicles approaching or crossing the warning line. The warning component includes a sliding installation in the threaded screw space. A threaded pusher, a water storage tank is connected to the lower side of the threaded screw space, the water storage tank is slidably connected to the threaded pusher, the upper side of the threaded pusher is rod-shaped, and the lower side is disc-shaped When the threaded push plate is moved to the right, the water in the water storage tank can be squeezed out and sprayed on the ground, and it can give a warning effect to pedestrians or vehicles doing dangerous actions.

2. The automatic command device for imitation traffic police according to claim 1, wherein the command component further comprises a gear space provided on the lower side of the stop card space and communicating with the stop card space. A helical gear space is provided at the rear side of the gear space, a motor is fixedly installed in the rear wall of the helical gear space, a driving shaft is fixedly installed on the motor output shaft, and a gear space is fixedly installed in the gear space on the driving shaft, The gear space meshes with the stop card base.

3. The automatic command device for imitation traffic police according to claim 1, characterized in that a spring space is provided on the left side of the stop card space and communicates with the stop card space, and the spring space is slidably installed in the spring space. A first slider, a first current-carrying magnet is fixedly installed in a right side surface of the first slider, a push rod is slidably installed in a right side of the first slider in the spring space, and a left side of the push rod is fixed inwardly A first permanent magnet is installed, a first spring is fixedly installed between a left wall of the spring space and a left side surface of the first slider, and a right side surface of the first energized magnet and a left side surface of the first permanent magnet are installed. A second spring is fixedly mounted on the upper side of the first slider, a fixed lever is fixedly mounted on the upper side of the first slider, a rocker is hinged on the fixed lever, and a passing card space with an upward opening is provided on the upper side of the stop card space. The pass card space is slidably connected with the second support rod. A hollow fixing block is fixedly installed on the lower side of the second support rod. A second permanent magnet is fixedly installed on the lower side of the hollow fixing block. The bottom wall of the pass card space is fixed inside. Install a second energizing magnet, Said second side surface of the permanent magnet between the side surface of the second electromagnet fixedly mounted through a third spring, the rocker is slidably connected to said hollow fixing block.

4. The automatic command device for imitation traffic police according to claim 1, characterized in that the warning component further comprises a helical gear space provided on the rear side of the gear space, and the active shaft is located on the oblique gear. A first helical gear is fixedly installed in the gear space, and a threaded screw space is provided on the left side of the helical gear space. A threaded screw is installed between the left and right walls of the threaded screw space, and the threaded screw is fixed in the helical gear space. A second helical gear is installed, the second helical gear meshes with the first helical gear, a threaded push plate is threadedly installed on the threaded screw, and a water storage tank is connected to the lower side of the threaded screw space. A plate extends into the water storage tank, and a spray head is provided between the right wall of the water storage tank and the right side of the fuselage. A water spray valve is fixedly installed in the spray head, and the bottom wall of the water storage tank is fixed. A water inlet valve is fixedly installed, and a support column for water inlet is fixedly installed on the lower side of the water inlet valve, and the lower side of the support column is fixedly installed in the ground.

5. The automatic command device for imitation traffic police according to claim 1, characterized in that: the front side of the gear space is provided with a fan blade space opening forward, and the active shaft is located in the fan blade space. The fan blade is fixedly installed, and a filter screen for preventing injury by the fan blade is fixedly installed on the front wall of the fan blade space.

6. The automatic command device for imitation traffic police according to claim 1, characterized in that: a water inlet pipe is arranged in the rear wall of the water storage tank, and a water outlet valve is fixedly installed in the water inlet pipe, and the inside of the fuselage A suction pump is fixedly installed, the input port of the suction pump is fixedly connected to the water inlet pipe, and the output pipe of the suction pump is fixedly connected to an output water pipe.
